(19) United States
(12) Patent Application Publication
(10) Pub. No.: US 2004/0125813 A1
(43) Pub. Date: Jul. 1, 2004

(54) Gateway and its communicating method

(76) Inventors: Mayuko Tanaka, Yokohama (JP); Yoshimichi Kudo, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/628,342

(22) Filed: Jul. 29, 2003

(30) Foreign Application Priority Data
Dec. 26, 2002 (JP) 2002-375860

(51) Int. Cl. H04L 12/28

(52) U.S. Cl. 370/401; 370/254; 709/220; 709/225

(57) ABSTRACT

A gateway as a node of a local network and a wide area network includes a first command processor for processing a first command according to a first network protocol which is used in the local network, a network configuration storing unit for storing gateway specifying information for specifying another gateway connected via the wide area network and a second command processor for processing a second command according to a second network protocol which is used in the wide area network and executing protocol conversion between the first network protocol and the second network protocol, thereby controlling permission or inhibition of communication on the basis of the gateway specifying information stored in the network configuration storing unit.

### BACKGROUND OF THE INVENTION

1. Field of the Invention

The present invention relates to a network device and a control method for the network devices and, more particularly, to a method for mutual communication of network devices among a plurality of networks each of which forms an independent network.

2. Description of the Related Art

In a home network, ease of use such that merely by connecting a device to the network, other devices are detected without making any special setting, thereby enabling their functions to be used is the most important. As one of techniques which satisfy such a requirement, UPnP (Universal Plug and Play) has been known (refer to “Universal Plug and Play Architecture”, version 1.0, Jun. 8, 2000).

As a method whereby the user of a local network in a first home remote-controls devices connected to a local network in a second home via a wide area network, there has been proposed a method whereby services which are provided to the networks by the devices connected to the local network are previously registered into directory agents and the user in the first home requests the directory agent of the second home to send information of the services which are provided by the network and operates the devices on the basis of the obtained information (refer to JP-A-11-187061, pages 18-20, FIG. 1).

### SUMMARY OF THE INVENTION

However, in the prior art disclosed in the above-referenced UPnP publication, the local home network is used as a target and nothing is considered with respect to the network which is configured via the wide area network. That is, according to the search in the UPnP publication, by using a multicast message, other devices are notified of connection of the device to the network or the existence of the devices which can be operated is found. If a system is adapted to the network which is configured via the wide area network, a notification indicative of the existence of the device connected to the local network which is transmitted from the device itself and a multicast message to search other devices are distributed all over the world. It is a problem from the view point of security and an increase in network traffic.

With respect to the JP-A-11-187061, by exchanging information with the directory agent existing on the local network connected via the wide area network, devices on the network existing at a remote position of the wide area network is also enabled to be seen by the user. However, the user has to preliminarily register information of services which are provided by the device connected to the network into the local directory agent.

In a network which is configured by connecting local networks via a wide area network, it is an object of the invention to provide means configured for a purpose such that network traffic is not increased and even if service information of a device which is provided to the networks is not previously registered into a directory agent, devices connected to the network are searched by the same method as that for a device connected to the local network, a function of the device which is provided to other devices via the network and detailed information for using the function are obtained, and a target device can be remote-controlled.

The above object is accomplished by the invention as defined in the claims.

According to one aspect of the invention, one network device can improve the remote control of other network devices.

Other objects, features and advantages of the invention will become apparent from the following description of the embodiments of the invention taken in conjunction with the accompanying drawings.

### BRIEF DESCRIPTION OF THE DRAWINGS

FIG. 1 shows constructions of networks and network devices according to an embodiment of the invention;

FIG. 2 shows an example of network configuration information which is stored in network configuration storing unit 116;

FIG. 3 shows an example of a flow of commands among the network devices;

FIG. 4 shows an example of kinds and functions of a network protocol command;

FIG. 5 shows an example of a packet format where a packet is transmitted and received in a network protocol;

FIG. 6 shows a configuration of a network and network devices according to another embodiment of the invention;

FIG. 7 shows an example of additional information of the network configuration information;

FIG. 8 shows an example of whole network participating device information which is stored in additional information unit; and

FIG. 9 shows another example of a flow of commands among the network devices.

### DETAILED DESCRIPTION OF THE EMBODIMENTS

An embodiment of the invention will be described hereinbelow with reference to the drawings.

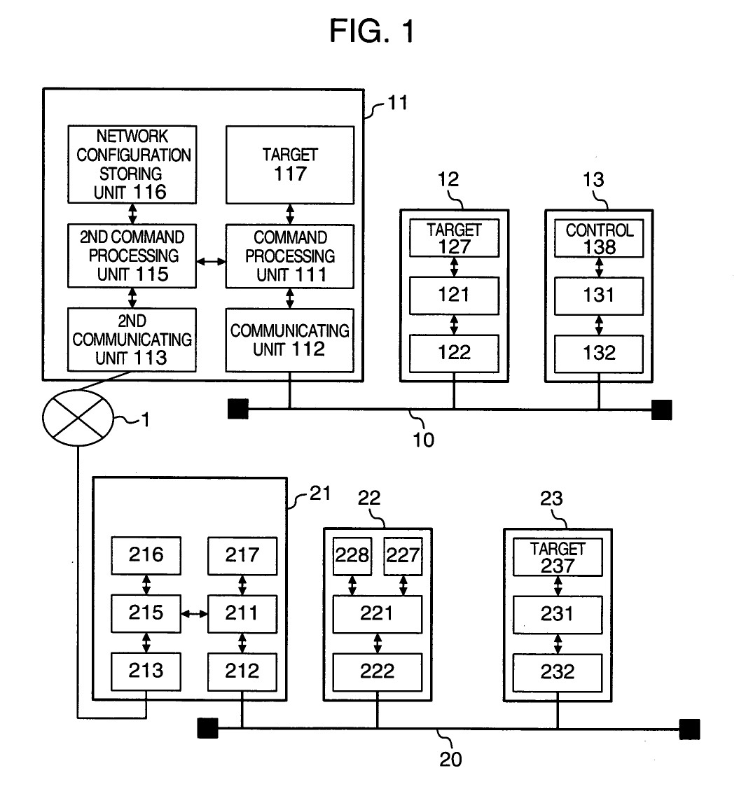

FIG. 1 shows an example of a configuration of a network and a configuration of network devices according to the embodiment of the invention.

First, the configuration of the networks will be described. Reference numeral 1 denotes a wide area network; 10 a local network in a first home; and 20 a local network in a second home. The network 10 includes a gateway 11 and network devices 12 and 13 and connected to the wide area network 1 via the gateway 11. The network 20 includes a gateway 21 and network devices 22 and 23 and connected to the wide area network 1 via the gateway 21.

Hereinbelow, a network which is configured by connecting the local networks of a plurality of homes via the wide area network is called a whole network. The local network of each home is connected to the wide area network by using the gateway as a node. A network including a plurality of gateways via the wide area network is called a virtual network.

In the case of FIG. 1, the whole diagram shows the whole network and the virtual network includes the wide area network 1 and the gateways 11 and 21.

Subsequently, the configuration of the network devices will be described. Reference numerals 12 and 13 denote the network devices connected to the network 10. Each of the network devices 12 and 13 has: a communicating unit 122 (132) which communicates with other network devices; and a command processing unit 121 (131) which receives a command according to a network protocol in the network 10, executes a process corresponding to the command, and issues a command. Reference numeral 127 denotes a target unit which allows the network device 12 to function as a target which is remote-controlled by a controller. The target unit 127 provides information necessary for the remote control and remote control unit to other network devices. The information necessary for the remote control includes, for example, a name of the function and a command which are provided to the network by the network device, a data format of the command, a transmission destination (for example, URL) of the command, and the like. The remote control unit is for receiving an operation command to operate the device, allowing the network device to operate in accordance with the command, and returning a value showing a status of the network device in accordance with a status referring command. Reference numeral 138 denotes a control unit which allows the network device 13 to function as a controller. The control unit 138 collects information of other network devices connected to the network and making remote control by using commands according to the network protocol. For example, a remote procedure call by message exchange using an SOAP (Simple Object Access Protocol) protocol is used.

The gateway 11 includes a communicating unit 112 and a command processing unit 111 and has a function as a network device similar to the network devices 12 and 13. The gateway 11 also has target unit 117 and plays a role of a target on the network 10.

Second command processing unit 115 receives a command according to a network protocol (hereinafter, referred to as a second network protocol) specified by the virtual network, executes a process corresponding to the command, issues a command, and executes protocol conversion between the network protocol which is used in the local network and the second network protocol. Reference numeral 116 denotes a network configuration storing unit which stores the IP addresses and the like of the network devices configuring the virtual network. Reference numeral 113 denotes a second communicating unit which connects to the wide area network.

The network device 22 is a network device having control unit 228 and target unit 227. The network device 23 is a network device having target unit 237. The gateway 21 has the same configuration as that of the gateway 11. Since functions of those units are substantially the same as those of the gateway 11 described before, their description is omitted here.

The target unit and the control unit provided for the network devices 12 and 13 and the gateway 11 function as a controller on the network or function as a target. Both units can be provided and it is not always necessary to provide either of them.

A method of configuring the virtual network and a method of realizing the remote control of the network devices will be described hereinbelow. First, a configuring procedure of the virtual network will be described.

The virtual network is configured by registering information for enabling the gateway 11 (21) to uniquely specify each other and access. The gateway on the side which requests the operation to configure the virtual network transmits a network configuring request command according to the second network protocol to a gateway of the partner's home. An IP address of the gateway of the partner's home is obtained by means such as a method of obtaining it from a domain name by using a public DNS (Domain Name System) server or the like. In this case, the gateway obtains the domain name from an Internet service provider or the like with which the user contracts and registers a domain name and an IP address of himself into the DNS server released onto the Internet. It is desirable that the gateway which received the network configuring request command confirms the partner by an authenticating process using a password or the like in order to assure safety and authenticates it. The information to enable the gateways to access mutually is exchanged and stored into each network configuration storing unit 116 (216). The information which is stored includes information for uniquely specifying the gateways configuring the virtual network, that is, the IP addresses, domain names, information such as IPSec or the like which is used for encryption of communication, and the like. In the case of a device such that the gateway can possess a plurality of IP addresses, there is a case where the gateway has an IP address for the whole network in addition to an IP address released to the public DNS server. In such a case, the IP addresses which are used in the whole network are exchanged and stored and, thereafter, communication is made by those IP addresses. By using the IP addresses which are not made public as mentioned above, the safety of the virtual network can be enhanced and the safety of the whole network can be improved.

The whole network is configured by forming the virtual network. That is, a network in which the local network 10 (20) to which the gateway 11 (21) configuring the virtual network is connected is included in the virtual network corresponds to a range of the whole network.

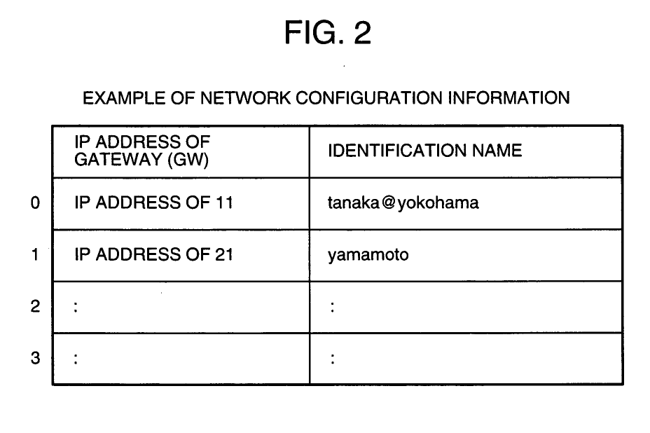

FIG. 2 shows an example of information which is stored into the network configuration storing unit 116. The IP address of the gateway and a name and a network identification name allocated to the network of each local in order to assist the user in understanding are stored.

Subsequently, processes of the gateway in the remote control of the network device in the whole network which is realized by forming the virtual network will be described. The case where the network device 13 of the network 10 remote-controls the network device 23 of the network 20 will be described here as an example.

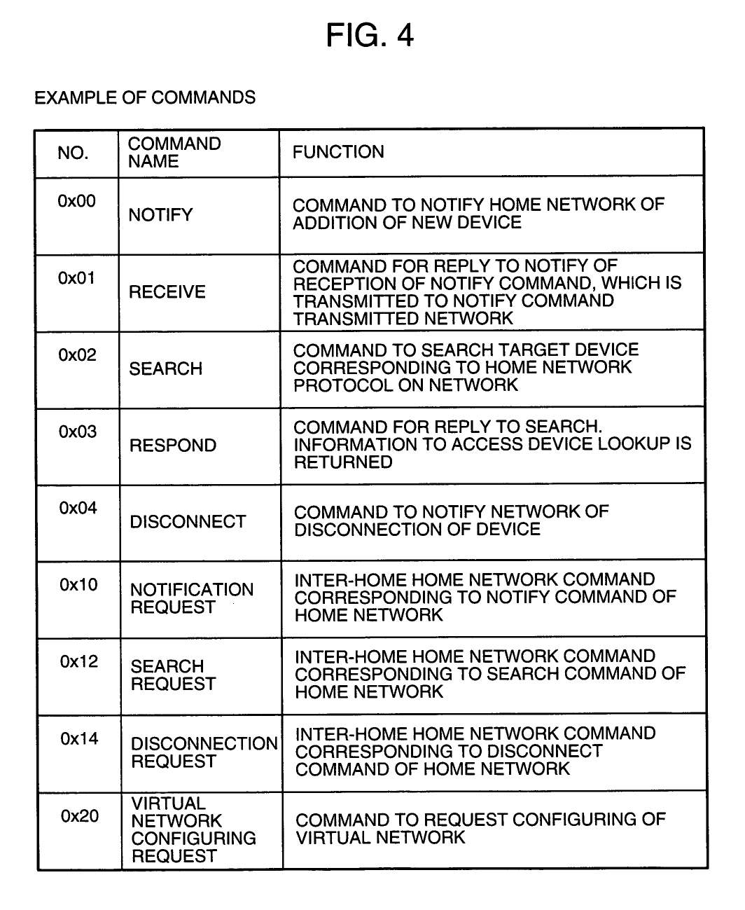

In the following description, commands according to the network protocol which are used in the local networks of the networks 10 and 20 are simply referred to as commands and commands according to the second network protocol specified in the virtual network are called second commands. Examples of kinds and functions of the commands which are used in both protocols are shown in FIG. 4.

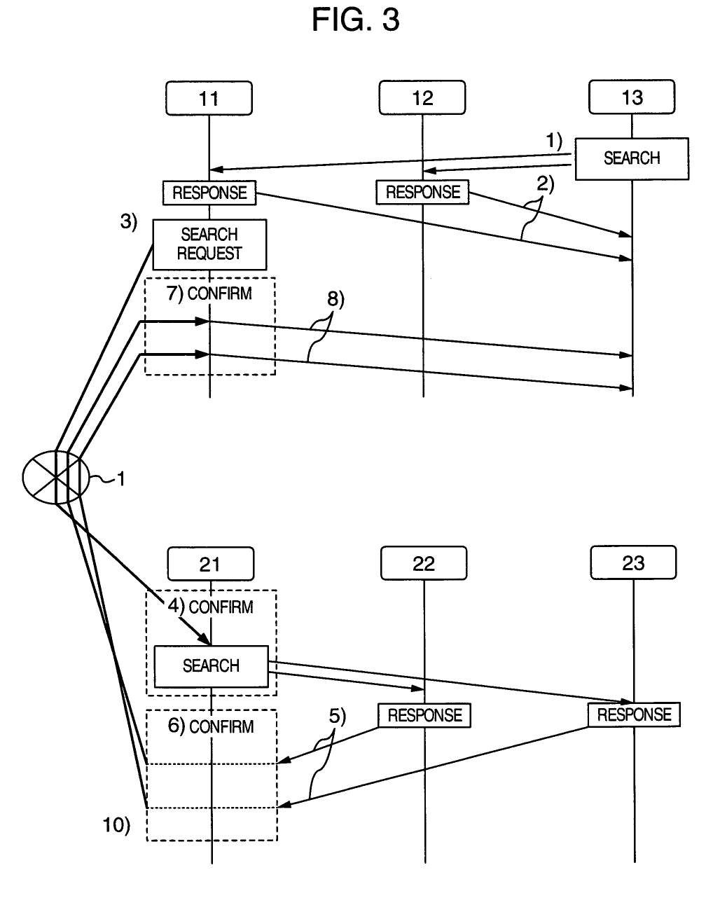

First, a searching process to find the network devices connected to the whole network will be described with reference to FIG. 3. FIG. 3 shows a flow of commands which are transmitted and received among the network devices.

1) The network device 13 issues a command “search” according to the network protocol to a link local multicast address of the network 10. This process is a general process in the home network as shown in the conventional technique.

2) The “search” command issued by the link local multicast address is received by all of the network devices connected to the network 10. The network device 12 processes the command by the command processing unit 121 and transmits a “response” command to the network device 13 as a reply of the “search” command. Similarly, the gateway 11 also processes the command by the command processing unit 111 and transmits a “response” command to the network device 13.

3) At the same time, the “search” command is also processed by the second command processing unit 115. The second command processing unit 115 confirms whether the local network 10 configures the whole network or not by referring to the network configuration storing unit 116. If the information of the network devices of other homes has been stored in the network configuration storing unit 116, it is determined that the whole network is configured, and a second command “search request” corresponding to the “search” command is issued. The second command “search request” is transmitted to global unicast addresses of the network devices of other homes recorded in the network configuration storing unit 116. In this example, it is transmitted to the home gateway 21. At this time, a global address of the network device 13 which issued the “search” command is added as a parameter.

Subsequently, a process of the gateway 21 which received the second command “search request” and a process in the network 20 to which the home gateway 21 belongs will be described.

4) The second command “search request” transmitted from the gateway 11 to the gateway 21 via the wide area network 1 is received by second communicating unit 213 and supplied to second command processing unit 215. The second command processing unit 215 confirms whether a sender (gateway 11) is a device configuring the virtual network or not with reference to the network configuration storing unit 216. If it is the device configuring the virtual network, the second command processing unit 215 allows command processing unit 211 to issue the command “search” corresponding to the “search request” command. At this time, it is assumed that a sender address is an address included in parameters of the “search request” command, that is, a global address of the network device 13 which issued the “search” command first. A destination address is assumed to be a link local multicast address of the network 20.

5) The “search” command issued at the link local multicast address is received by all of the network devices connected to the network 20. Each of the network devices 22 and 23 processes the command by command processing unit 221 (231) and transmits a command “response” of a reply to the “search” command at the global address of the network device 13 serving as a sender of the “search” command. At this time, a global address of each of the network devices 22 and 23 which transmit the “response” command is used as a sender address of the “response” command.

6) In the whole network, the local networks and the wide area network are always connected via the gateways. That is, “response” messages from the network devices 22 and 23 to the network device 13 are received once by the gateway device 21 and sent to the second command processing unit 215. The second command processing unit 215 confirms whether the destination (network device 13) is a device configuring the whole network or not with reference to the network configuration storing unit 216. As a confirming method, a method of comparing the addresses of the devices configurating the virtual network recorded in the network configuration storing unit 216 or address prefixes and discriminating that the network device is a device which belongs to the same network, or the like is used. Only when it is determined that it is the communication toward the wide area network and with the network devices configurating the whole network, the “response” commands are transmitted to the network device 13 via the second communicating unit 213.

Subsequently, the processes of the gateway 11 which received the “response” commands will be described.

7) First, the “response” commands returned to the network device 13 from the network devices of the network 20, that is, the network devices 22 and 23 and the gateway 21 are received via the second communicating unit 113 of the gateway 11 and sent to the second command processing unit 115. The second command processing unit 115 confirms whether the devices are network devices configuring the whole network of the “response” commands or not with reference to the network configuration storing unit 116. Only when it is determined that it is the communication from the network devices configuring the whole network, the second command processing unit 115 sends the “response” commands to the network device 13 via the local network 10. A confirming method is the same as that shown in the above process 6).

By the series of processes, the network device 13 can receive the “response” commands to the “search” command from all of the network devices configuring the whole network, that is, the network device 12, the gateway 11, and the network devices 22 and 23 and the home gateway 21 of the network 20 connected via the external network 1 without being aware of the connecting positions of the network devices and know the existence of the devices.

In the embodiment, the “search” command issued by the network device 13 toward the link local multicast address of the local network 10 is transmitted as a “search request” command at the global unicast addresses of the gateways configuring the virtual network by the gateway 11. The gateway on the transmission destination issues the “search” command at the link local multicast address of the local network, so that the “search” command issued by the network device 13 is transmitted to the whole network. Since the communication in the wide area network uses the unicast address, it does not increase the network traffic.

The processes of the “search” command and the “response” commands of the replies thereto have been described above. Also with respect to other “notify” command and “disconnect” command, the command can be transmitted to the network devices configuring the whole network and replies to it can be received without changing the processes of the network devices connected to the local networks.

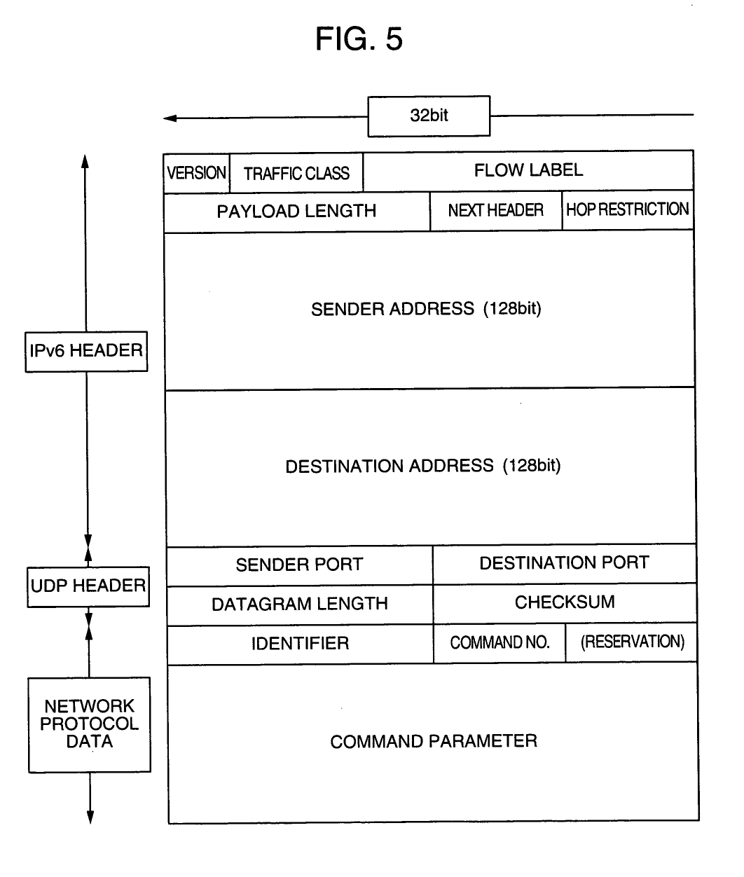

An example of a packet format when an IPv6 protocol is used for a network layer and a UDP (User Datagram Protocol) protocol is used for a transport layer is shown in FIG. 5. An identifier of a network protocol data portion indicates that the command is a command according to the virtual network protocol and a certain value has been predetermined. A command number is a number showing the kind of command and corresponds to the number in FIG. 4. Necessary information is stored in a command parameter in accordance with the command.

The network device 13 finds a network device which can be remote-controlled by the “search”. A response from the remote-controllable network device includes URL information. The network device 13 obtains device information necessary for operation of the remote-controllable network device by accessing the URL information. The network device 13 obtains command information, parameter information, a URL of a command transmission destination, and the like for remote-controlling the target network device from the device information and executes the target operation.

Communication for obtaining the above two device information and transmission of an operation command are executed by HTTP communication using the URL. Therefore, the one-to-one corresponding communication between the network devices is made and there is no fear of increase in network traffic. However, there is an anxiety from the viewpoint of security. As a method of raising the security, there is a method of making authentication and approval each time communication from an external network is received or communication toward the external network is made. However, according to such a method, the user is burdened since he has to enter a password or the like, so that it is inconvenient. Thus, there is a fear such that he feels the burden tiresome, he changes the settings so that he does not make any authentication or approval, and eventually, there are more risks.

In the embodiment, therefore, the gateway confirms the sender and the destination even in the case of the one-to-one corresponding communication between the network devices such as communication for obtaining the device information, transmission of the operation command, or the like. That is, in both of the cases where the communication is made from the local network device toward the wide area network and where, contrarily, the communication from the wide area network to the local network device is received, network managing unit of the gateway confirms them with reference to the network configuration storing unit. Whether the communication is communication from the network device configuring the whole network or communication toward the network devices configuring the whole network is confirmed. In the former case, the communication is permitted. Whether the communication is communication toward the local network device from the network device not configuring the whole network or communication toward the network device not configuring the whole network from the local network device is confirmed. In the latter, the communication is rejected.

By using such a method, the network device connected to the local network can communicate regardless of whether the network device as a communication partner is connected to the local network or connected via the wide area network. Further, since the communication with devices other than the network devices configuring the whole network is rejected, an illegal access to the network devices of the local network or an illegal access to the wide area network, such as illegal use of the network devices of the local network due to a DOS attack can be prevented. Effects of the embodiment are not limited on homes.

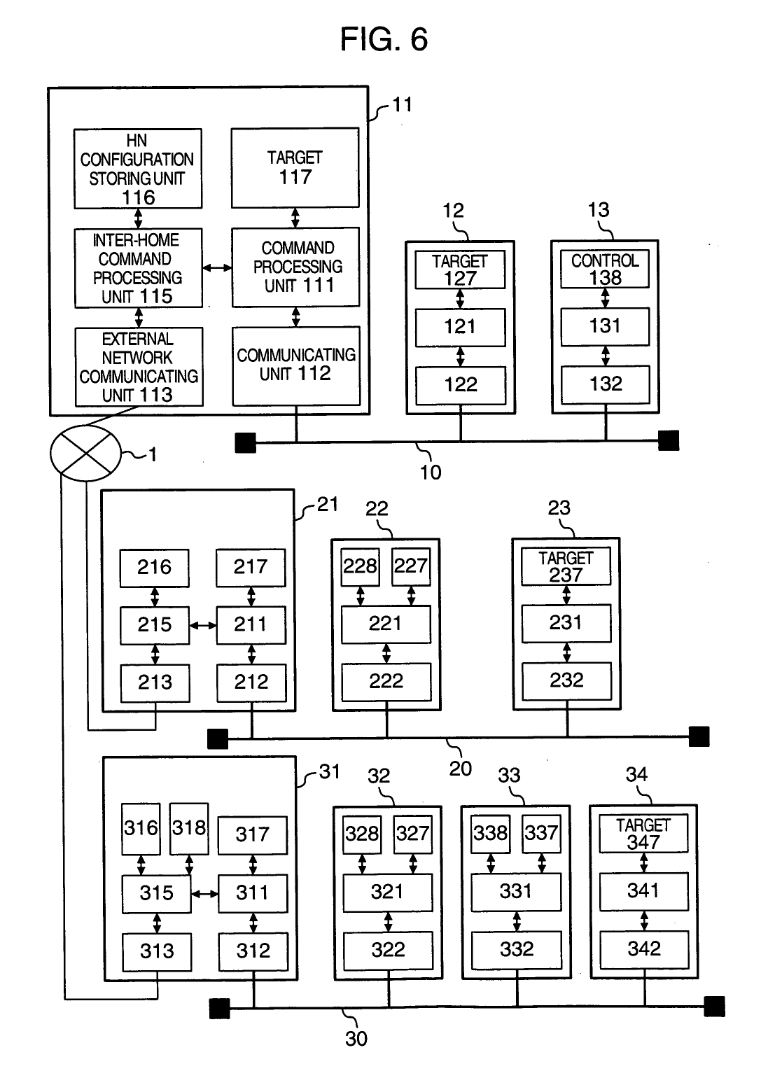

FIG. 6 shows an example of a configuration of a network and network devices according to another embodiment of the invention.

First, the configuration of the network will be explained. Reference numeral 1 denotes the wide area network and 10, 20, and 30 indicate local networks in different homes. The network 10 includes the gateway 11 and the network devices 12 and 13 and connected to the wide area network 1 via the gateway 11. The network 20 includes the gateway 21 and the network devices 22 and 23 and connected to the wide area network 1 via the gateway 21. The network 30 also similarly includes a gateway 31 and network devices 32, 33, and 34 and connected to the wide area network 1 via the gateway 31.

Since the configuration and functions of each network device are substantially the same as those described in FIG. 1, their explanation is omitted. Reference numeral 318 of the gateway 31 denotes accompanying information storing unit. The local network devices which participate in the whole network are registered and stored every whole network configured by them and the gateways which are stored in network configuration storing unit 316.

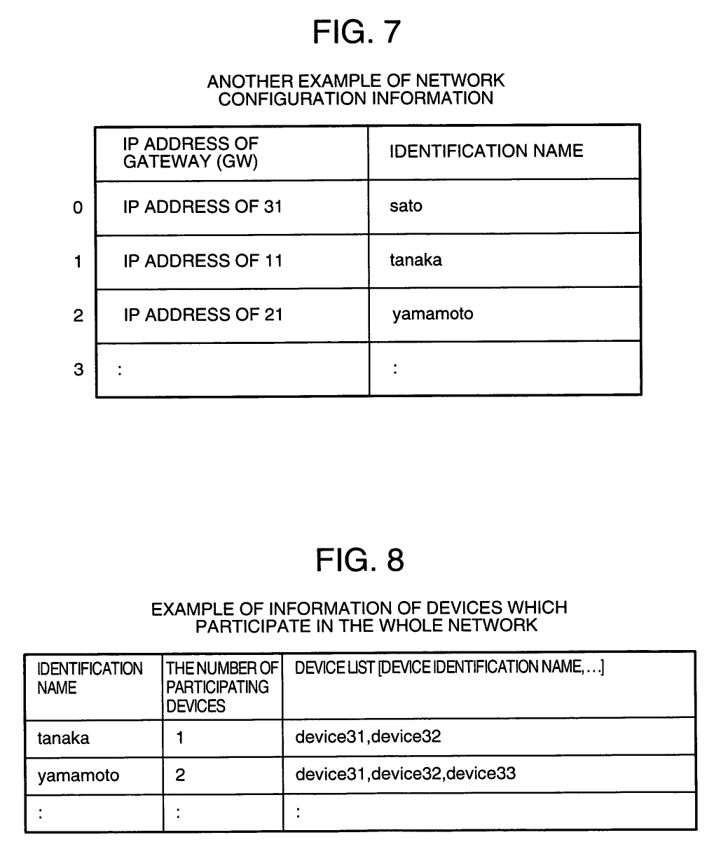

FIG. 7 shows an example of information which is stored by the network configuration storing unit 316 of the gateway 31. The diagram shows that the gateway 31 configures a virtual network together with the gateways 11 and 12. That is, the diagram shows that the local network 30 configures a whole network together with the local network 10 via the wide area network 1 and configures a whole network together with the local network 20 via the wide area network 1.

The information of the network devices which participate in the whole network is stored in the accompanying information storing unit 318 every home (every gateway) of the partner as shown in FIG. 8. As information which is stored, any information such as IP addresses, device identification names, or the like can be stored so long as the network devices can be uniquely specified in the local network.

FIG. 8 shows that network devices 31 and 32 participate in the whole network configured together with the network 10 (identification name “tanaka”) and network devices 31, 32, and 33 participate in the whole network configured together with the network 20 (identification name “yamamoto”), respectively. The information which is stored into the accompanying (additional) information storing unit can be also stored into the network configuration storing unit.

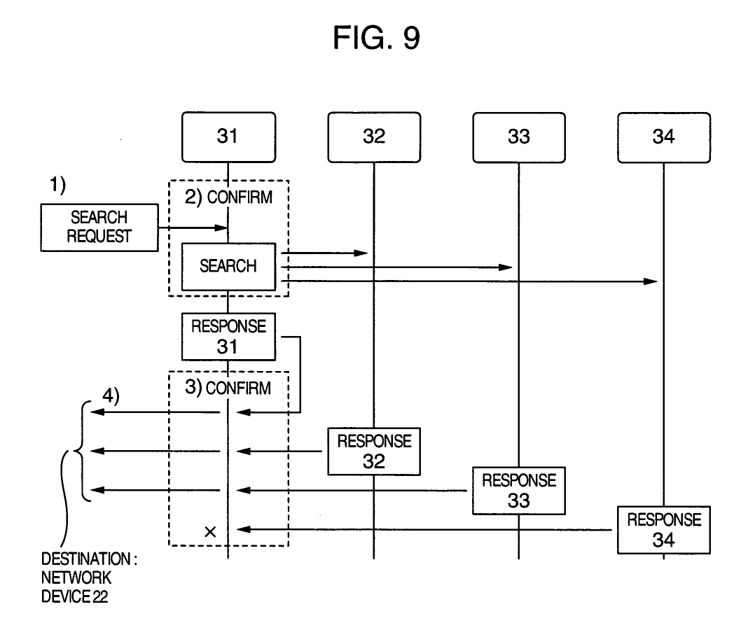

In another embodiment, command processes of the gateway 31 in the whole network will be described hereinbelow with reference to FIG. 9. A case where the gateway 31 receives the “search request” command from the gateway 21 corresponding to the “search” command issued by the network device 22 will be described as an example.

1) The gateway 21 transmits the second command “search request” to the gateway 31 configuring the virtual network. The second command “search request” is processed by second command processing unit 315. If it is confirmed that the communication is made from the gateway 21 configuring the virtual network with reference to the network configuration storing unit 316, the second command processing unit 315 requests command processing unit 311 to issue the command “search” corresponding to the “search request”.

2) The command processing unit 311 requested to issue the command “search” issues the “search” command to the link local multicast address of the network 30. At this time, the sender address is assumed to be the address included in the parameters of the “search request” command, that is, the global address of the network device 22 which first issued the “search” command. The destination address is assumed to be the link local multicast address of the network 30.

3) The “search” command issued by the link local multicast address is received by all of the network devices connected to the network 30. In the network device 32 (33, 34), the command is processed in command processing unit 321 (331, 341) and a “response” command is transmitted to the network device 22 as a reply to the “search” command. The “response” command toward the network device 22 is communicated toward the wide area network 1. Such communication is once received by the gateway 31 and transferred to the second command processing unit 315. The second command processing unit 315 confirms whether the destination (network device 22) is a device configuring the whole network or not with reference to the network configuration storing unit 316. If it is determined that it is the communication toward the wide area network and with the network device configuring the whole network, whether each network device participates in the whole network with the transmission destination or not is confirmed.

4) That is, whether the network device which transmitted the “response” command participates in the whole network or not is confirmed with reference to the accompanying information storing unit 318. Only the “response” commands from the network devices which participate in the whole network are transmitted to the network device 22 on the destination side. Therefore, if the network device which transmitted the “response” command does not participate in the whole network, the “response” command is not transmitted. For example, if the device which transmitted the “search request” is the gateway 21, since the network device 34 does not participate in the whole network, the “response” command from the network device 34 is not transmitted to the network device 22.

Although the accompanying information storing unit has been provided on the side to which the “search request” is transmitted in the embodiment, the accompanying information storing unit can be provided on the side which transmits the “search request” or can be also provided on both sides.

If the accompanying information storing unit is provided on the transmitting side, the “search request” command of the gateway corresponding to the “search” command issued by the network device is transmitted only to the gateway in which the network device participates in the whole network. The network devices which participate in the whole network can be made different every gateway device. If the network device which issued the “search” command does not participate in the whole network, the “search request” command of the gateway is not transmitted.

In the case where the accompanying information storing unit is provided on both sides, if the network device participates in the whole network at the time of the gateway on the side to which the “search request” is transmitted, the “search request” command is transmitted. If the network device which transmits the “response” command participates in the whole network at the time of the gateway on the side which transmits the “search request”, the “response” command is transmitted to the gateway which transmitted the “search request” command.

In the embodiment mentioned so far, as shown in FIG. 8, the accompanying information storing unit stores the information of the network device which participates in the whole network every gateway on the partner side. However, the invention is not limited to it but the information of the network device which participates in the whole network can be stored every network device which is managed by the gateway on the partner side.

As network configuration information of the embodiment so far, not only the partner's gateway which configures the virtual (whole) network but also the IP address of the gateway itself at which the network configuring information has been registered is registered (FIGS. 2 and 7). However, the invention is not limited to it but can be also configured in a manner such that even if the IP address of the gateway itself at which the network configuration information has been registered is not registered, if the partner's gateway has been registered, the virtual (whole) network can be formed.

From the above configuration, it is possible to provide the gateway in which GW specifying information or device specifying information such as an IP address or the like is stored into the network configuration storing unit or the accompanying information storing unit and the permission or inhibition of the communication can be controlled by the second command processing unit on the basis of the specifying information.

By storing the information of the network devices which participate in the whole network into the additional information storing unit besides the storage information in the network configuration storing unit, the network devices which are remote-controlled by the whole network can be arbitrarily set without changing the configuration of the network devices connected to the local network and the processes of the local network devices.

According to the gateway in the embodiment mentioned above, among the network devices configuring the whole network, the network device can realize a series of processes such that the network devices on the whole network are searched, the device information for the remote control is obtained, and the remote control is executed by substantially the same procedure as that of the processes according to the network protocol of the local network. That is, the network device connected to the local network can communicate and can be remote-controlled without being conscious of a discrimination result about whether the partner's network device is the network device connected via the wide area network.

Since the multicast communication with the wide area network is not used, there is no fear of increase in traffic of the wide area network. Further, a safe network which can prevent the reception of an illegal access from the outside and an illegal access to the external network in which the local network device is used as a springboard can be configured without increasing a burden on the local network device.

In addition, since whether the network device participates in the whole network or not is set every network device, it is possible to provide a network environment such that the information of the network device which does not participate in the whole network is not transferred to the wide area network.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A gateway as a node of a local network and a wide area network, comprising:
command processing means for processing a first command according to a first network protocol which is used in said local network;
network configuration storing means for storing gateway specifying information for specifying another gateway connected via said wide area network; and
second command processing means for processing a second command according to a second network protocol which is used in said wide area network and executing protocol conversion between said first network protocol and said second network protocol,
thereby controlling permission or inhibition of communication on the basis of the gateway specifying information stored in said network configuration storing means.

2. A gateway according to claim 1, further comprising accompanying information storing means for storing device specifying information for specifying a network device connected to a local network of said another gateway,
thereby controlling the permission or inhibition of the communication on the basis of the device specifying information stored in said accompanying information storing means.

3. A gateway according to claim 1, wherein said gateway specifying information is at least one of a global IP address, a domain name, and information for using encrypted communication.

4. A gateway according to claim 1, wherein said gateway specifying information is an IP address different from a global IP address released to a domain name system DNS server.

5. A gateway according to claim 1, wherein when a first command to search said whole local network is received, a second search command is transmitted to said another gateway specified by said gateway specifying information.

6. A gateway according to claim 1, wherein when a second search command transmitted from said another gateway specified by said gateway specifying information is received, a first command to search said whole local network of said gateway is transmitted.

7. A communicating method in a gateway as a node of a local network and a wide area network, comprising:
a receiving step of receiving a first command according to a first network protocol which is used in said local network;
a converting step of converting the first command received in said receiving step into a second command according to a second network protocol which is used in said wide area network; and
a communication control step of controlling permission or inhibition of communication on the basis of gateway specifying information for specifying another gateway connected via said wide area network.

8. A communicating method in a gateway as a node of a local network and a wide area network, in which
a first command conforms with a first network protocol which is used in said local network, and
a second command conforms with a second network protocol which is used in said wide area network,
wherein said method comprises:
a receiving step of receiving the second command transmitted from said wide area network;
a converting step of converting the second command received in said receiving step into said first command; and
a communication control step of controlling permission or inhibition of communication on the basis of device specifying information for specifying a network device connected to said local network of said gateway.
